(19) United States
(12) Patent Application Publication
(10) Pub. No.: US 2023/0407008 A1
(43) Pub. Date: Dec. 21, 2023

(54) POLYAMIDE COMPOSITION

(71) Applicant: SOLVAY SPECIALITY POLYMERS USA, LLC, Alpharetta, GA (US)

(72) Inventors: David McIlroy, Johns Creek, GA (US); Matthew Vincent, Buford, GA (US)

(73) Assignee: SOLVAY SPECIALITY POLYMERS USA, LLC, Alpharetta, GA (US)

(21) Appl. No.: 18/253,123

(22) PCT Filed: Nov. 3, 2021
(86) PCT No.: PCT/EP2021/080555

§ 371 Date: May 16, 2023

Related U.S. Application Data
(60) Provisional application No. 63/114,117, filed on Nov. 16, 2020.

(30) Foreign Application Priority Data
Jan. 11, 2021 (EP) 21150952.6

(51) Int. Cl. C08G 69/26; C08G 69/28; C08K 7/06; C08K 7/14; C08K 3/34; C09D 177/06; C09D 7/40; C09D 7/61

(52) U.S. Cl. CPC C08G 69/265; C08G 69/28; C08K 7/06; C08K 7/14; C08K 2003/343; C09D 177/06; C09D 7/70; C09D 7/61; C08K 3/34

(57) ABSTRACT

A polyamide composition is provided and comprises at least one polyamide characterized by high glass transition temperature (Tg), at least one fibrous filler and at least one additive, wherein the composition can be used to manufacture articles, and in electrostatic painting applications.

### CROSS-REFERENCE TO RELATED APPLICATIONS

This application claims priority to U.S. Provisional Patent Application Ser. No. 63/114,117, filed Nov. 16, 2020, and to European Patent Application No. 21150952.6, filed Jan. 11, 2021, each of which hereby being incorporated by reference herein in their entirety for all purposes.

### FIELD

A polyamide composition is provided comprising at least one polyamide characterized by high glass transition temperature (Tg), at least one fibrous filler and at least one additive, wherein the composition can be used to manufacture articles suitable for electrostatic painting applications.

### BACKGROUND

The paint finish on a new vehicle is often regarded as the single most noticeable visual feature of the vehicle. When the finish is smooth, even and attractive, persons viewing the vehicle are likely to be influenced as to the quality of the vehicle in a positive manner. Conversely, when the paint finish contains defects, persons viewing the vehicle are likely to attribute a lack of quality to the vehicle generally.

Accordingly, vehicle manufacturers and paint suppliers have expended vast resources to produce enhanced paint application processes to improve the quality and durability of the finish of the vehicle and eliminate defects associated with the application of paint to the vehicle.

Despite the efforts made, there remains a need for compositions showing good adhesion between the substrate and the base coat of electrostatically applied paint (also referred to as “E-coat process”), while maintaining good mechanical properties and high glass transition temperature (Tg).

### SUMMARY

A composition is provided comprising a polyamide polymer having high glass transition temperature which is suitable for E-coat process while showing good mechanical properties.

In a first aspect, the present invention relates to a composition [composition (C)] comprising:
from 20 to 85 wt. % based on the total weight of the composition, of at least one polyamide polymer [polymer (PA)] having a glass transition temperature (Tg), measured by DSC, of at least 130° C., more preferably of at least 150° C.;
from 10 to 75 wt. % based on the total weight of the composition, of at least one fibrous filler [filler (F)]; and
from 0.01 to less than 5 wt. % based on the total weight of the composition, of at least one additive [additive (A)] selected from the group consisting of oxides of alkaline earth metals; carbonates of alkaline earth metals; phosphates of alkaline earth metals; sulphates of alkaline earth metals; sulphates of alkaline metals; carbonates of alkaline metals; oxides of group IIB metals of the periodic table; sulphides of group IIB metals of the periodic table; and mineral filler.

### DETAILED DESCRIPTION

Preferably, polymer (PA) has at least 50 mol. % recurring units having at least one amide bond (—NH—C(═O)—).

As used herein, mol. % of recurring units is relative to the total number of moles of recurring units in the indicated polymer (e.g. the polymer (PA)), unless explicitly noted otherwise.

In some embodiments, the polyamide has at least 60 mol. %, at least 70 mol. %, at least 80 mol. %, at least 90 mol. %, at least 95 mol. %, at least 99 mol. % or at least 99.5 mol. % of recurring units having at least one amide bond.

In some embodiments, the polyamide polymer (PA) is formed from the polycondensation of a reaction mixture [reaction mixture (RM)] including a diamine component and a dicarboxylic acid component. The diamine component and the dicarboxylic acid component include each of the diamines and dicarboxylic acids, respectively, in the reaction mixture. In some such embodiments, at least 50 mol. %, at least 70 mol. %, at least 80 mol. %, at least 90 mol. %, at least 95 mol. %, at least 99 mol. % or at least 99 mol. % of the recurring units of the polyamide polymer (PA) is formed from the polycondensation of the reaction mixture (RM).

Each diamine in the diamine component is distinct and can be, independently, either aliphatic or aromatic and represented by the formula:

H₂N—R₁—NH₂

wherein
R₁ is selected from the group consisting of a bond, a C₁-C₁₅ alkyl and a C₆-C₃₀ aryl, optionally comprising one or more heteroatoms (e.g. O, N or S) and optionally substituted with one or more substituents selected from the group consisting of halogen, hydroxy (—OH), sulfo (—SO₃M), C₁-C₆ alkoxy, C₁-C₆ alkylthio, C₁-C₆ acyl, formyl, cyano, C₆-C₁₅ aryloxy and C₆-C₁₅ aryl and
M is selected from the group consisting of H, Na, K, Li, Ag, Zn, Mg and Ca.

Preferably, said aliphatic diamine is selected from the group consisting of: diamine-propane (“3”), 1,3-diaminobutane, 1,4-diaminobutane, 1,5-diaminopen-tane, 2-methyl-1,5-diaminopentane (“D”), 1,6-diaminohexane (“HMDA”), 3-methylhexamethylenediamine, 2,5-dimethylhexamethylenediamine, 2,2,4-trimethyl-hexamethylenediamine, 2,4,4-trimethyl-hexamethylenediamine, 1,7-diaminoheptane, 1,8-diaminooctane, 2,2,7,7- tetramethyloctamethylenediamine, 1,9-diaminononane, 2-methyl-1,8-diaminooctane, 5-methyl-1,9-diaminononane, 1,10-diaminodecane, 1,11-diaminoundecane, 1,12-diaminododecane, 1,13-diaminotridecane, 2,5-diamonotetrahydrofurane and N,N-Bis(3-aminopropyl)methylamine.

Aliphatic diamines also include cycloaliphatic diamines.

Preferred cycloaliphatic diamines are selected from the group consisting of: isophorone diamine, 1,3-diaminocyclohexane, 1,4-diaminocyclohexane, bis-p-aminocyclohexylmethane, 1,3-bis(aminomethyl)cyclohexane (“1,3-BAC”), 1,4-bis(aminomethyl)cyclohexane (“1,4-BAC”), bis(3-methyl-4-aminocyclohexyl) methane (“MACM”), and bis(4-aminocyclohexyl)methane (“PACM”).

Preferably, the aliphatic diamine is selected from the group consisting of 1,3-diaminopropane (“3”), 1,4-diaminobutane, 1,5-diaminopentane, HMDA, 2-methyl-1,5-diaminopentane (“D”), 1,3-BAC, 1,4-BAC, PACM, MACM and isophorone diamine.

Preferred aromatic diamines are selected from the group consisting of: m-phenylene diamine (“MPD”), p-phenylene diamine (“PPD”), 3,4′-diaminodiphenyl ether (“3,4′-ODA”), 4,4′-diaminodiphenyl ether (“4,4′-ODA”), p-xylylene diamine (“PXDA”) and m-xylylenediamine (“MXDA”).

More preferably, the aromatic diamine is selected from the group consisting of PXDA and MXDA.

Each dicarboxylic acid in the dicarboxylic acid component is distinct and can be, independently, either aliphatic or aromatic, and represented by the following formula:

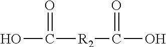

wherein
R₂ is selected from the group consisting of a C₁-C₂₀ alkyl, a phenyl, an indanyl, and a napthyl, optionally comprising one or more heteroatoms (e.g. O, N or S) and optionally substituted with one or more substituents selected from the group consisting of halogen, hydroxy (—OH), sulfo (—SO₃M), C₁-C₆ alkoxy, C₁-C₆ alkylthio, C₁-C₆ acyl, formyl, cyano, C₆-C₁₅ aryloxy and C₆-C₁₅ aryl and
M is selected from the group consisting of H, Na, K, Li, Ag, Zn, Mg and Ca.

Preferred aliphatic dicarboxylic acids are selected from the group consisting of: oxalic acid, malonic acid, succinic acid, glutaric acid, 2,2 dimethyl glutaric acid, adipic acid (“6”), 2,4,4 trimethyl-adipic acid, pimelic acid, suberic acid, azelaic acid, sebacic acid, undecanedioic acid, dodecandioic acid (“12”), tridecanedioic acid, tetradecanedioic acid, pentadecanedioic acid, hexadecanedioic acid, octadecanedioic acid.

Aliphatic dicarboxylic acids also include cycloaliphatic dicarboxylic acids.

Preferred cycloaliphatic dicarboxylic acids are selected from the group consisting of 1,4-cyclohexane dicarboxylic acid (“CHDA”), adipic acid (“6”), and sebacic acid (“10”). More preferably, the aliphatic dicarboxylic acid is CHDA.

Preferred aromatic dicarboxylic acids are selected from the group consisting of: isophthalic acid (“IA”), terephthalic acid (“TA”), naphthalenedicarboxylic acids (“NDA”) (e.g. naphthalene-2,6-dicarboxylic acid (“2,6-NDA”)), 4,4′-bibenzoic acid, 2,5-pyridinedicarboxylic acid, 2,4-pyridinedicarboxylic acid, 3,5-pyridinedicarboxylic acid, 2,2-bis(4-carboxyphenyl)propane, 2,2-bis(4-carboxyphenyl) hexafluoropropane, 2,2-bis(4-carboxyphenyl)-ketone, 4,4′-bis(4-carboxyphenyl)sulfone, 2,2-bis(3-carboxyphenyl)-propane, 2,2-bis(3-carboxyphenyl)hexafluoropropane, 2,2-bis(3-carboxy-phenyl)ketone, and bis(3-carboxyphenoxy)benzene.

More preferably, the aromatic dicarboxylic acid is selected from the group consisting of IA, TA and 2,6-NDA.

Each recurring unit formed by the polycondensation of the reaction mixture (RM) is distinct and independently represented by the following formula:

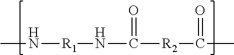

where R1, R2 and M are defined as above.

The person of ordinary skill in the art will recognize that each recurring unit is formed by the dehydrogenation of a diamine and the dehydroxylation of the dicarboxylic acid.

In some embodiments, said polymer (PA) is the condensation product of:
at least one diamine component selected from aliphatic, cycloaliphatic diamines and mixtures thereof and
at least dicarboxylic acid component selected from aliphatic, cycloaliphatic, aromatic dicarboxylic acids and mixtures thereof.

In some embodiments, said polymer (PA) is the condensation product of
at least one diamine component selected from the group consisting of: 1,3-diaminopropane (“3”), 1,3-diaminobutane, 1,4-diaminobutane, 2-methyl-1,5-diaminopentane (“D”), 2,5-dimethylhexa methylenediamine, 2,2,4-trimethyl-hexamethylenediamine, 2,4,4-trimethyl-hexamethylenediamine, 3-methylhexamethylenediamine, 1,6-diaminohexane (“HMDA” or “6”), 1,3-bis(aminomethyl)cyclohexane (“1,3-BAC”), 1,4-bis(aminomethyl)cyclohexane (“1,4-BAC”), bis(3-methyl-4-aminocyclohexyl) methane (“MACM”), bis(4-aminocyclohexyl)methane (“PACM”), and mixtures thereof; and
at least one dicarboxylic acid component selected from the group consisting of: terephthalic acid (“TA”), isophthalic acid (“IA”), 1,4-cyclohexane dicarboxylic acid (“CHDA”), dodecandioic acid (“12”), sebacic acid (“10”), undecanedioic acid, and mixtures thereof.

In some embodiments, polymer (PA) is formed from the polycondensation of a reaction mixture (RM) including:
a diamine component including at least one diamine selected from the group consisting of: 1,3-diaminopropane (“3”), 1,3-diaminobutane, 1,4-diaminobutane, 1,6-diaminohexane (“HMDA” or “6”), bis(3-methyl-4-aminocyclohexyl) methane (“MACM”), bis(4-aminocyclohexyl)methane (“PACM”), and mixtures thereof; and
a dicarboxylic acid component including at least one dicarboxylic acid selected from the group consisting of: terephthalic acid (“TA” or “T”), isophthalic acid (“IA” or “I”), 1,4-cyclohexane dicarboxylic acid (“CHDA”), dodecandioic acid (“12”), and mixtures thereof.

In some embodiments, polymer (PA) is selected from the group consisting of: 46/6T; [6/3]/T; MACM/12; [PACM/MACM]/[I/12]; 6T/DT; [4,6,D]/[T/I]; 6T/6I; [6/BAC]/[T/CHDA].

Preferably, polymer (PA) has a number average molecular weight Mn ranging from 1,000 g/mol to 40,000 g/mol, for example from 2,000 g/mol to 35,000 g/mol or from 4,000 to 30,000 g/mol. The number average molecular weight Mn can be determined by gel permeation chromatography (GPC) using ASTM D5296 with polystyrene standards.

Preferably, said polymer (PA) has a glass transition temperature (T_{g}) of at least 130° C., preferably at least 135° C. In some embodiments, polymer (PA) has a T_{g} of no more than 190° C., no more than 180° C., or no more than 170° C. In some embodiments, polymer (PA) has a T_{g} of from 135° C. to 190° C., from 140° C. to 190° C., from 145° C. to 185° C., from 150° C. to 185° C., from 150° C. to 180° C., or from 150° C. to 170° C. T_{g} can be measured according to ASTM D3418.

Preferably, said polymer (PA) has a melting point (Tₘ) of no more than 360° C., more preferably of no more than 350° C., even more preferably of no more than 340° C., determined using differential scanning calorimeter (DSC) according to ASTM D3418.

Preferably, said polymer (PA) has a melting point (Tₘ) of at least 280° C., more preferably of at least 295° C., even more preferably of at least 300° C., determined using differential scanning calorimeter (DSC) according to ASTM D3418.

Preferably, composition (C) comprises said polymer (PA) in an amount from 25 to 80 wt. %, more preferably from 30 to 75 wt. % and even more preferably from 35 to 70 wt.% based on the total weight of composition (C).

Composition (C) further comprises from 10 to 75 wt. % based on the total weight of the composition, of at least one fibrous filler [filler (F)].

As used within the present description and the following claims, a “fibrous filler [filler (F)]” is a material having a length, width and thickness, where the average length is significantly larger than both the width and thickness. Preferably, such a material has an aspect ratio, defined as the average ratio between the length and the smallest of the width and thickness of at least 5.

Preferably, said filler (F) is selected from at least one of glass fiber, carbon fiber, synthetic polymeric fiber, aramid fiber, aluminum fiber, titanium fiber, magnesium fiber, boron carbide fiber, rock wool fiber, and steel fiber. Glass fiber and carbon fiber are most preferred.

The fibers may be in the form of whiskers, short fibers, continuous fibers, sheets, plies, and combinations thereof.

Continuous fibers may further adopt any of unidirectional, multi-dimensional, non-woven, woven, knitted, stitched, wound, and braided configurations, as well as swirl mat, felt mat, and chopped mat structures. The fiber tows may be held in position in such configurations by cross-tow stitches, weft-insertion knitting stitches, or a small amount of resin, such as a sizing.

As used herein, “continuous fibers” are fibers having a length greater than 10 mm.

According to an embodiment, filler (F) is carbon fiber.

Carbon fibers useful for the present invention can be obtained by heat treatment and pyrolysis of different polymer precursors such as, for example, rayon, polyacrylonitrile (PAN), aromatic polyamide or phenolic resin; suitable carbon fibers may also be obtained from pitchy materials. A variety of carbon fibers known to those of skill in the art are available from commercial sources.

In some embodiments, the carbon fiber is a standard modulus carbon fiber or an intermediate modulus carbon fiber. Standard modulus carbon fibers have a tensile modulus of from 227 GPa to 235 GPa. Intermediate modulus carbon fibers have a tensile modulus of from 282 GPA to 289 GPa.

The carbon fiber can be a virgin carbon fiber or a recycled (post-consumer or postindustrial) carbon fiber (pyrolyzed or over-sized).

In some embodiments, the carbon fiber has an average length of at least 1 mm, at least 3 mm, at least 4 mm, at least 5 mm or at least 6 mm. In some embodiments, the glass fiber has an average length of no more than 10 mm. In some embodiments, the carbon fiber has an average length of from 1 mm to 10 mm, from 3 mm to 10 mm, from 4 mm to 10 mm, from 5 mm to 10 mm or more 6 mm to 10 mm.

According to another embodiment, filler (F) is glass fiber.

Glass fibers may have a round cross-section or a non-circular cross-section (so called “flat glass fibers”), including oval, elliptical or rectangular cross-section.

Advantageously, glass fibers used in the composition (C) of the invention are flat glass fibers.

In some embodiments, the flat glass fiber has an aspect ratio of at least 2, preferably at least 2.2, more preferably at least 2.4, still more preferably at least 3. Additionally or alternatively, in some embodiments, the flat glass fiber has an aspect ratio of at most 8, preferably at most 6, more preferably of at most 4.

The aspect ratio is defined as a ratio of the longest diameter in the cross-section of the glass fiber to the shortest diameter in the same cross-section.

In some preferred embodiments, the flat glass fiber has an aspect ratio of from 2 to 6, and preferably, from 2.2 to 4.

The glass fibers may be added as continuous fibers or as chopped glass fibers.

The glass fibers have generally an equivalent diameter of 5 μm to 20 μm preferably of 5 μm to 15 μm and more preferably of 7 μm to 12 μm.

All glass fiber types, such as A, C, D, E, M, ECR, S, R, T glass fibers (as described in chapter 5.2.3, pages 43-48 of Additives for Plastics Handbook, 2nd ed., John Murphy), or any mixtures thereof or mixtures thereof may be used. E- and S-glass fibers are most preferred.

Preferably, composition (C) comprises said filler (F) in an amount from 10 to 70 wt. %, more preferably from 20 to 65 wt. % based on the total weight of composition (C).

According to a preferred embodiment, when filler (F) is selected from carbon fiber, the amount of filler (F) in the composition (C) is from 2 to 55 wt. %, more preferably from 5 to 50 wt. %, even more preferably from 8 to 45 wt. % based on the total weight of composition (C).

According to a preferred embodiment, when filler (F) is selected from glass fibers, the amount of filler (F) in the composition (C) is from 25 to 75 wt. %, more preferably from 35 to 65 wt. % based on the total weight of composition (C).

According to another preferred embodiment, filler (F) comprises, more preferably consists of, a mixture of carbon fibers and glass fibers.

According to this embodiment, the total amount of filler (F) in the composition (C) is preferably from 7 to 40 wt. % based on the total weight of the composition (C).

Preferably, the weight ratio of the carbon fiber to glass fiber (weight of carbon fiber in composition (C)/weight of glass fiber in composition (C)) is at least 0.05, at least 0.15, at least 0.2, at least 0.5, at least 0.75, or at least 1. In some embodiments in which composition (C) includes carbon fiber and glass fiber, the weight ratio of the carbon fiber to the glass fiber is no more than 4, no more than 3, no more than 2 or no more than 1. In some embodiments, in which composition (C) includes carbon fiber and glass fiber, the weight ratio of the carbon fiber to the glass fiber is from 0.05 to 4, from 0.05 to 3, from 0.05 to 2, from 0.05 to 1, from 0.15 to 4, from 0.15 to 3, from 0.15 to 2, from 0.15 to 1, from 0.2 to 5, from 0.2 to 4, from 0.2 to 3, from 0.2 to 1, from 0.5 to 4, from 0.5 to 3, from 0.5 to 2 from 0.5 to 1, from 1 to 4, from 1 to 3 or from 1 to 2.

Composition (C) further comprises from 0.01 to less than 5 wt. % based on the total weight of the composition, of at least one additive (A).

Preferably, said additive (A) is selected from the group consisting of: oxides of alkaline earth metals (the most preferred being CaO), carbonates of alkaline earth metals (the most preferred being CaCO₃), phosphates of alkaline earth metals (the most preferred being Ca₃(PO₄)₂); sulphates of alkaline earth metals; sulphates of alkaline metals (the most preferred being Na₂SO₄), carbonates of alkaline metals (the most preferred being Na₂CO₃); oxides of group IIB metals (the most preferred being ZnO); sulphides of group IIB metals (the most preferred being ZnS); and mineral fillers (the most preferred being wollastonite, talc and zeolite).

Preferably, composition (C) comprises said additive (A) in an amount from preferably from 0.05 to less than 3 wt. %, more preferably from 0.10 to less than 2 wt. % and even more preferably to less than 1 wt. % based on the total weight of said composition (C).

Composition (C) may comprise only one additive (A) or a mixture of said additives (A). The embodiment wherein composition (C) comprises only one additive (A) as detailed above is more preferred.

Optionally, composition (C) comprises additional ingredients, such as pigments, dyes, tougheners, ultraviolet light stabilizers, heat stabilizers, antioxidants, acid scavengers, processing aids, nucleating agents, lubricants, flame retardants, smoke-suppressing agents, anti-static agents, anti-blocking agents, and carbon black.

When one or more of the above mentioned ingredients are present, their total concentration is preferably less than 10 wt. %, more preferably less than 5 wt. %, and most preferably less than 2 wt. %, based on the total weight of composition (C).

The composition is advantageously prepared by melt-blending said at least one polymer (PA) with said at least one filler (F) and said at least one additive (A).

Preferably, mixing the polymer (PA) and said at least one filler (F) and at least additive (A) is carried out by dry blending and/or melt compounding. More preferably, mixing the polymer (PA) and said at least one filler (F) and at least additive (A) is carried out by melt compounding, notably in continuous or batch devices.

Preferably, the ingredients are fed into a melt mixer, such as single screw extruder or twin screw extruder, agitator, single screw or twin screw kneader, or Banbury mixer, and the addition step may be addition of all ingredients at once or gradual addition in batches.

When the ingredients are gradually added in batches, a part of the polymeric ingredients and/or non-polymeric ingredients is first added, and then is melt-mixed with the remaining polymeric ingredients and non-polymeric ingredients that are subsequently added, until an adequately mixed composition is obtained.

If a filler (F) or additive (A) presents a long physical shape (for example, long fibers as well as continuous fibers), drawing extrusion or pultrusion may be used to prepare a reinforced composition.

Composition (C) is advantageously used for manufacturing articles.

Preferably, said articles are formed by subjecting composition (C) to a process adapted to thermoplastics, e.g. extrusion, injection molding, blow molding, rotomolding or compression molding.

Articles comprising composition (C) as defined above are also provided.

Composition (C) wherein filler (F) is selected from carbon fibres or a mixture of carbon fibers and glass fibers, is advantageously used to manufacture articles suitable for electrostatic painting, such as painted articles for use in automotive applications.

For sake of brevity, composition (C) wherein said filler (F) consists of carbon fibers or comprises an admixtures of carbon fibers and glass fibers will be herein after referred to as “composition (C1)”.

An article comprising a composition [composition (C1)] is provided and comprises:
from 20 to 85 wt. % based on the total weight of the composition, of at least one polyamide polymer [polymer (PA)] having a glass transition temperature (T_{g}), measured by DSC, of at least 130° C., more preferably of at least 150° C.;
from 10 to 75 wt. % based on the total weight of the composition, of at least one fibrous filler [filler (F)] selected from: carbon fibres or a mixture of carbon fibers and glass fibers; and
from 0.01 to less than 5 wt. % based on the total weight of the composition, of at least one additive [additive (A)] selected from the group consisting of: oxides of alkaline earth metals; carbonates of alkaline earth metals; phosphates of alkaline earth metals; sulphates of alkaline earth metals; sulphates of alkaline metals; carbonates of alkaline metals; oxides of group IIB metals of the periodic table; sulphides of group IIB metals of the periodic table; and mineral filler.

The carbon fibers and/or the glass fibers in composition (C1) have the properties as defined above for composition (C) and can be used in the amounts defined above for composition (C).

A method for painting an article using composition (C1) as defined above is also provided, wherein said method is performed via electrostatic painting, immersion-in-flowing-powder painting method, spray method, and electrodeposition coating method.

Preferably, said method for painting a substrate is performed via electrostatic painting.

The invention will be herein after illustrated in greater detail by means of the Examples contained in the following Experimental Section; the Examples are merely illustrative and are by no means to be interpreted as limiting the scope of the invention.

### EXPERIMENTAL SECTION

### Materials & Methods

Polyamide 1: PA 6, T/1,3-BAC, T/6,CHDA/1,3-BAC,CHDA (having Tg=165° C. and Tₘ=330° C.), the co-monomers were as follows
hexamethylenediamine (70 wt %, from Ascend Performance Materials)
1,3-bis(aminomethyl)cyclohexane (from Mitsubishi Gas Chemical Company)
terephthalic acid (from Flint Hills Resources)
1,4-cyclohexanedicarboxylic acid (from Eastman Chemical Company)

Polyamide 2: Radipol® S24 PA6 was obtained from Radici Group

Nucleating agent: Mistron® Vapor R (talc) was obtained from Imerys Performance Materials

Filler 1: Tenax®-J HT C₄₉₃ (carbon fibres) was obtained from Teijin

Filler 2: ChopVantage® HP 3610 (circular E-glass fibers having diameter of 10 μm) was obtained from Nippon Electric Glass

Toughner: Royaltuf™ 498 maleic anhydride grafted EPDM was obtained from Addivant

Modifier: VitaCal O (calcium oxide) was obtained from Mississippi Lime

Additive package 1: containing pigment (carbon black CPTA-25759) and heat stabilizer (HS pellet blend)—CPTA-35759 masterbatch of carbon black and polyamide, was obtained from Clariant; HS pellet blend heat stabilizer for polyphthalamides prepared by Ajay North America

Additive package 2: containing heat stabilizer for olefin (Naugard™ 445 aromatic amine) was obtained from Addivant

DSC (Differential Scan Calorimetry)

DSC was used to measure the glass transition temperature (Tg) of the composition using the following:
instrument: TA Instruments DSC Q20-2
carrier gas 1 for nitrogen with 99.998% purity
flow rate: 50 ml/min
method: ASTM D3418-15
method log: (1: Equilibrate at 30.00° C. (2: Ramp 20.00° C./min to 350.00° C. (3: Isothermal for 1.00 min (4: Mark end of cycle 1 (5: Ramp 20.00° C./min to 0.00° C. (6: Mark end of cycle 2 (7: Ramp 20.00° C./min to 360.00° C. (8: Mark end of cycle 3 (9: End of method

Melt Stability

Melt stability was performed using a LCR-7000 Capillary Rheometer. Material was loaded into the capillary rheometer and remained in the barrel under negligible shear. The melt viscosity at 1200 s⁻¹ was measured at 5 and 10 minutes of barrel time. Melt stability is given as the ratio between the 5-minute viscosity and the 10-minute viscosity (T5/T10).

Paintability Test

The test was perform in triplicate, on panels having a painted film thereon of 0.8 mm thick.

The scribing tool was a Olfa® Knife using either a 2 or 3 mm blade spacing template.

The adhesion rating scale was as follows:

0→The edges of the cuts were completely smooth; none of the squares of the lattice was detached.

1→Detachment of small flakes of the coating at the intersections of the cuts. A cross-cut area of 5% maximum was affected.

2→The coating has flaked along the edges and/or at the intersections of the cuts. A cross-cut area of 5% minimum but 15% maximum was affected.

3→The coating had flaked along the edges of the cuts partly or wholly in large ribbons, and/or it has flaked partly or wholly on different parts of the squares. A cross-cut area of 15% minimum but 35% maximum was affected.

4→The coating had flaked along the degrees of the cuts in large ribbons and/or some squares have detached partly or wholly. A cross-cut area of 35% minimum but 65% maximum was affected.

5→A cross-cut area of >65% was affected.

The initial adhesion had to be rated 0 for a “pass”.

After water soak (exposure for 24 Hours at 60 +1° C. deionized water immersion) 0 was “pass”, 1 was “marginal pass” and 2 or higher was “fail”.

### Synthesis of Polyamide 1

Polyamide 1 was prepared in an autoclave reactor equipped with a distillate line fitted with a pressure control valve. The reactor was charged with 498 g of 70% hexamethylenediamine, 165 g of 1,3-bis(aminomethyl)cyclohexane, 635 g of terephthalic acid, 20 g of 1,4-cyclohexanedicarboxylic acid, 355 g of deionized water, 7.2 g of glacial acetic acid and 0.32 g of phosphorus acid. The reactor was sealed, purged with nitrogen and heated to 260° C. The steam generated was slowly released to keep the internal pressure at 120 psig. The temperature was increased to 335° C. The reaction mixture was kept at 335° C. for 60 minutes while the reactor pressure was reduced to atmospheric. The polymer was discharged from the reactor and used in the preparation of the compound formulations.

### Example (A): Preparation of Compositions and Testing

The compositions detailed in the following Table 1 were prepared by mixing the listed ingredients in the given amounts using a Coperian ZSK-26 TSE Co-Rotating Compounding Extruder.

TABLE 1

| | Control | | | | |
|---|---|---|---|---|---|
| Ingredients | A(*) | E-1 | CE-1(*) | CE-3(*) | CE-4(*) |
| Polyamide 1 | 67.66 | 67.16 | 62.66 | 62.41 | 57.41 |
| Nucleating | 0.5 | 0.5 | 0.5 | 0.5 | 0.5 |
| Agent | | | | | |
| Additive | 1.84 | 1.84 | 1.84 | 1.84 | 1.84 |
| Package 1 | | | | | |
| Filler 1 | 30 | 30 | 30 | 30 | 30 |
| Additive | — | — | — | 0.25 | 0.25 |
| Package 2 | | | | | |
| Polyamide 2 | — | — | 5 | — | — |
| Toughener | — | — | — | 5 | 10 |
| Modifier | — | 0.5 | — | — | — |

(*)comparison

The thermal properties and the paintability of the above compositions were measured according to the methods described above. The results are summarized in the following Table 2.

TABLE 2

| | Control | | | | |
|---|---|---|---|---|---|
| | A(*) | E-1 | CE-1(*) | CE-3(*) | CE-4(*) |
| T5/T10 | 1.87 | 1.89 | 2.07 | 2.05 | 1.49 |
| Tg (° C.) | 151.74 | 152.67 | 129.66 | 151.75 | 151.57 |
| Paintability | fail | pass | fail | fail | pass |
| initial | | | | | |
| 24 h water | — | pass | — | — | marginal |
| soak | | | | | pass |

(*)comparison

The results in Table 2 clearly show that the inventive composition (E-1) had significantly improved paintability compared to compositions (Control, CE-1 and CE-3) without the modifier, while at the same time showing a high Tg.

The mechanical properties of the composition passing the paintability test after 24 hours of water soak were evaluated. The results are summarized in the following Table 3.

TABLE 3

| Properties | E-1 | CE-4(*) |
|---|---|---|
| Tensile modulus (MPa) | 23900 | 19600 |
| Tensile strength (MPa) | 232 | 195 |
| Flexural modulus (MPa) | 22600 | 18800 |
| Flexural strength (MPa) | 332 | 295 |

(*)comparison

The results in Table 3 clearly show that the inventive composition (E-1) maintained good mechanical properties. Comparative composition (CE-4) comprising high amount of toughener 2 showed acceptable paintability but the mechanical properties were negatively affected.

### Example (B): Preparation of Compositions and Testing

The compositions detailed in the following Table 4 were prepared by mixing the listed ingredients in the given amounts using a Coperian ZSK-26 TSE Co-Rotating Compounding Extruder.

TABLE 4

| | Control | |
|---|---|---|
| Ingredients | B(*) | E-2 |
| Polyamide 1 | 47.66 | 47.16 |
| Nucleating Agent | 0.5 | 0.5 |
| Additive Package 1 | 1.84 | 1.84 |
| Additive Package 2 | — | — |
| Filler 2 | 50 | 50 |
| Polyamide 2 | — | — |
| Toughener | — | — |
| Modifier | — | 0.5 |

(*)comparison

The mechanical properties of the above compositions were evaluated. The results are summarized in the following Table 5.

TABLE 5

| | Control | |
|---|---|---|
| Properties | B(*) | E-2 |
| Tensile modulus (MPa) | 18100 | 18200 |
| Tensile strength (MPa) | 237 | 176 |
| Flexural modulus (MPa) | 18100 | 18100 |
| Flexural strength (MPa) | 354 | 304 |

(*)comparison

The results in Table 5 clearly show that the inventive composition (E-2) maintained good balance of mechanical properties compared to the control composition.

Should the disclosure of any patents, patent applications, and publications which are incorporated herein by reference conflict with the description of the present application to the extent that it may render a term unclear, the present description shall take precedence.

While only certain features of the invention have been illustrated and described herein, many modifications and changes will occur to those skilled in the art. It is to be understood that the appended claims are intended to cover all such modifications and changes as fall within the spirit of the invention.

1. A composition (C) comprising:
from 20 to 85 wt. % based on the total weight of the composition, of at least one polyamide polymer (PA) having a glass transition temperature (T_{g}), measured by DSC, of at least 130° C.;
from 10 to 75 wt. % based on the total weight of the composition, of at least one fibrous filler (F); and
from 0.01 to less than 5 wt. % based on the total weight of the composition, of at least one additive (A) selected from the group consisting of: oxides of alkaline earth metals; carbonates of alkaline earth metals; phosphates of alkaline earth metals; sulphates of alkaline earth metals; sulphates of alkaline metals; carbonates of alkaline metals; oxides of group IIB metals of the periodic table; sulphides of group IIB metals of the periodic table; and mineral filler.

2. The composition (C) according to claim 1, wherein at least 50 mol. % of the recurring units of said polymer (PA) is formed from the polycondensation of a reaction mixture (RM) including a diamine component comprising at least one diamine; and a dicarboxylic acid component comprising at least one dicarboxylic acid.

3. The composition (C) according to claim 2, wherein:
said diamine is an aliphatic diamine selected from the group consisting of 1,3-diamine-propane (“3”), 1,3-diaminobutane, 1,4-diaminobutane, 1,5-diaminopentane, 2-methyl-1,5-diaminopentane (“D”), 1,6-diaminohexane (“HMDA” or “6”), 3-methylhexamethylenediamine, 2,5-dimethylhexamethylenediamine, 2,2,4-trimethyl-hexamethylenediamine, 2,4,4-trimethyl-hexamethylenediamine, 1,7-diaminoheptane, 1,8-diaminooctane, 2,2,7,7- tetramethyloctamethy-lenediamine, 1,9-diaminononane, 2-methyl-1,8-diaminooctane, 5-methyl-1,9-diaminononane, 1,10-diaminodecane, 1,11-diaminoundecane, 1,12-diaminododecane, 1,13-diaminotridecane, 2,5-diamonotetrahydrofurane, N,N-Bis(3-aminopropyl)methylamine, and mixtures thereof, or
said diamine is an cycloaliphatic diamine selected from the group consisting of:
isophorone diamine, 1,3-diaminocyclohexane, 1,4-diaminocyclohexane, bis-p-aminocyclohexylmethane, 1,3-bis(aminomethyl)cyclohexane (“1,3-BAC”), 1,4-bis(aminomethyl)cyclohexane (“1,4-BAC”), bis(3-methyl-4-aminocyclohexyl) methane (“MACM”), bis(4-aminocyclohexyl)methane (“PACM”), and mixtures thereof; or
said diamine is an aromatic diamine selected from the group consisting of: m-phenylene diamine (“MPD”), p-phenylene diamine (“PPD”), 3,4′-diaminodiphenyl ether (“3,4′-ODA”), 4,4′-diaminodiphenyl ether (“4,4′-ODA”), p-xylylene diamine (“PXDA”) and m-xylylenediamine (“MXDA”); and
said dicarboxylic acid is an aliphatic dicarboxylic acid selected from the group consisting of: oxalic acid, malonic acid, succinic acid, glutaric acid, 2,2 dimethyl glutaric acid, adipic acid (“6”), 2,4,4 trimethyl-adipic acid, pimelic acid, suberic acid, azelaic acid, sebacic acid (“10”), undecanedioic acid, dodecandioic acid (“12”), tridecanedioic acid, tetradecanedioic acid, pentadecanedioic acid, hexadecanedioic acid, octadecanedioic acid; or
said dicarboxylic acid is a cycloaliphatic dicarboxylic acids acid which is 1,4-cyclohexane dicarboxylic acid (“CHDA”); or
said dicarboxylic acid is an aromatic dicarboxylic acid selected from the group consisting of: isophthalic acid (“IA”), terephthalic acid (“TA”), naphthalenedicarboxylic acids (“NDA”), 4,4′-bibenzoic acid, 2,5-pyridinedicarboxylic acid, 2,4-pyridinedicarboxylic acid, 3,5-pyridinedicarboxylic acid, 2,2-bis(4-carboxyphenyl)propane, 2,2-bis(4-carboxyphenyl)hexafluoro propane, 2,2-bis(4-carboxyphenyl)-ketone, 4,4′-bis(4-carboxyphenyl) sulfone, 2,2-bis(3-carboxyphenyl)-propane, 2,2-bis(3-carboxyphenyl)hexa fluoropropane, 2,2-bis(3-carboxy-phenyl)ketone, and bis(3-carboxy phenoxy)benzene.

4. The composition (C) according to claim 1, wherein said polymer (PA) is formed from the polycondensation of a reaction mixture (RM) including:
at least one diamine component selected from aliphatic, cycloaliphatic diamines and mixtures thereof and
at least dicarboxylic acid component selected from aliphatic, cycloaliphatic, aromatic dicarboxylic acids and mixtures thereof.

5. The composition (C) according to claim 4, wherein said polymer (PA) is formed from the polycondensation of a reaction mixture (RM) including:
at least one diamine component selected from the group consisting of: 1,3-diaminopropane (“3”), 1,3-diaminobutane, 1,4-diaminobutane, 2-methyl-1,5-diaminopentane (“D”), 2,5-dimethylhexa methylenediamine, 2,2,4-trimethyl-hexamethylenediamine, 2,4,4-trimethyl-hexamethylenediamine, 3-methylhexamethylenediamine, 1,6-diaminohexane (“HMDA” or “6”), 1,3-bis(aminomethyl)cyclohexane (“1,3-BAC”), 1,4-bis(aminomethyl)-cyclohexane (“1,4-BAC”), bis(3-methyl-4-aminocyclohexyl) methane (“MACM”), bis(4-aminocyclohexyl)methane (“PACM”), and mixtures thereof; and
at least one dicarboxylic acid component selected from the group consisting of: terephthalic acid (“TA” or “T”), isophthalic acid (“IA” or “I”), 1,4-cyclohexane dicarboxylic acid (“CHDA”), dodecandioic acid (“12”), sebacic acid, undecanedioic acid, and mixtures thereof.

6. The composition (C) according to claim 5, wherein said polymer (PA) is formed from the polycondensation of a reaction mixture (RM) including:
at least one diamine component selected from the group consisting of: 1,3-diaminopropane (“3”), 1,3-diaminobutane, 1,4-diaminobutane, 1,6-diaminohexane (“HMDA” or “6”), bis(3-methyl-4-aminocyclohexyl) methane (“MACM”), bis(4-aminocyclohexyl)methane (“PACM”), and mixtures thereof; and
at least one dicarboxylic acid component selected from the group consisting of: terephthalic acid (“TA” or “T”), isophthalic acid (“IA” or “I”), 1,4-cyclohexane dicarboxylic acid (“CHDA”), dodecandioic acid (“12”), and mixtures thereof.

7. The composition (C) according to claim 6, wherein said polymer (PA) is selected from the group consisting of: 46/6T; [6/3]/T; MACM/12; [PACM/MACM]/[I/12]; 6T/DT; [4,6,D]/[T/I]; 6T/6I; [6/BAC]/[T/CHDA].

8. The composition (C) according to claim 1, wherein said polymer (PA) has
a number average molecular weight (Mn) (determined by gel permeation chromatography (GPC) using ASTM D5296 with polystyrene standards) ranging from 1,000 g/mol to 40,000 g/mol; and/or
a glass transition temperature (T_{g}) (measured according to ASTM D3418) of at least 130° C., and of no more than 190° C; and/or
a melting point (Tₘ) (determined using differential scanning calorimeter (DSC) according to ASTM D3418) of no more than 360° C.

9. The composition (C) according to claim 1, wherein said additive (A) is selected from the group consisting of: CaO, CaCO₃, Ca₃(PO₄)₂, Na₂SO₄, Na₂CO₃, ZnO, ZnS, wollastonite, talc, and zeolite.

10. The composition (C) according to claim 1, wherein said additive (A) is in an amount from 0.05 to less than 3 wt. % based on the total weight of said composition (C).

11. The composition (C) according to claim 1, wherein said filler (F) is selected from at least one of glass fiber, carbon fiber, synthetic polymeric fiber, aramid fiber, aluminum fiber, titanium fiber, magnesium fiber, boron carbide fiber, rock wool fiber, steel fiber, and mixtures thereof.

12. The composition (C) according to claim 11, wherein said filler (F) is selected from glass fibers, carbon fibers or a mixture thereof.

13. The composition (C) according to claim 12, wherein said filler (F) comprises glass fibers in an amount from 25 to 75 wt. % based on the total weight of composition (C).

14. The composition (C) according to claim 12, wherein said filler (F) comprises:
carbon fibers, in an amount from 2 to 55 wt. % based on the total weight of composition (C); or
a mixture of carbon fibers and glass fibers, in an amount from 7 to 40 wt. % based on the total weight of the composition (C) and wherein the weight ratio of the carbon fiber to glass fiber is at least 0.05 and no more than 4.

15. An article comprising composition (C) according to claim 1.

16. A method for painting an article as defined in claim 15, wherein the painting is performed via immersion-in-flowing-powder painting method, spray method, and electrodeposition coating method.

17. An article comprising a composition (C1) comprising:
from 20 to 85 wt. % based on the total weight of the composition, of at least one polyamide polymer (PA) having a glass transition temperature (T_{g}), measured by DSC, of at least 130° C.;
from 10 to 75 wt. % based on the total weight of the composition, of at least one fibrous filler (F) selected from: carbon fibers or a mixture of carbon fibers and glass fibers; and
from 0.01 to less than 5 wt. % based on the total weight of the composition, of at least one additive (A) selected from the group consisting of: oxides of alkaline earth metals; carbonates of alkaline earth metals; phosphates of alkaline earth metals; sulphates of alkaline earth metals; sulphates of alkaline metals; carbonates of alkaline metals; oxides of group IIB metals of the periodic table; sulphides of group IIB metals of the periodic table; and mineral filler.

18. A method for painting an article as defined in claim 17, wherein the painting is performed via electrostatic painting.

19. The composition (C) according to claim 1, wherein at least 50 mol. % of the recurring units of said polymer (PA) is formed from the polycondensation of a reaction mixture (RM) including a diamine component comprising at least one diamine, selected from aliphatic diamine, cycloaliphatic diamine and/or aromatic diamine; and a dicarboxylic acid component comprising at least one dicarboxylic acid, selected from aliphatic dicarboxylic acid, cycloaliphatic dicarboxylic acid and/or aromatic dicarboxylic acid.

20. The composition (C) according to claim 1, wherein said polymer (PA) has a glass transition temperature (T_{g}) (measured according to ASTM D3418) of at least 135° C. and of no more than 190° C.
